(19) United States
(12) Patent Application Publication
(10) Pub. No.: US 2013/0232326 A1
(43) Pub. Date: Sep. 5, 2013

(54) Electronic Device Booting Method and Electronic Device Applying the Same

(71) Applicant: ASUSTEK COMPUTER INC., Taipei (TW)

(72) Inventor: Tien-Jui Lin, Taipei (TW)

(73) Assignee: ASUSTEK COMPUTER INC., Taipei (TW)

(21) Appl. No.: 13/773,800

(22) Filed: Feb. 22, 2013

(30) Foreign Application Priority Data
Mar. 5, 2012 (TW) 101107316

(51) Int. Cl. G06F 11/22

(52) U.S. Cl. CPC G06F 11/2284
USPC 713/2

(57) ABSTRACT

An electronic device booting method includes following steps: booting the electronic device when a power button of the electronic device is triggered; determining if a preset button of the electronic device is triggered; initializing at least one specific hardware element of the electronic device when the preset button is triggered; and executing an operation system (OS) before the specific hardware element is initiated when the preset button is not triggered. An electronic device is also disclosed.

### CROSS-REFERENCE TO RELATED APPLICATION

This application claims the priority benefit of Taiwan application serial No. 101107316, filed on Mar. 5, 2012. The entirety of the above-mentioned patent application is hereby incorporated by reference herein and made a part of specification.

### BACKGROUND OF THE INVENTION

1. Field of the Invention

The invention relates to an electronic device booting method and an electronic device applying the same and, more particularly, to an electronic device rapid booting method and an electronic device applying the same.

2. Description of the Related Art

Conventionally, when the user presses a power button of a computer, the computer boots. In the booting process of the computer, a power on self-test (POST) is executed first via a basic input/output system (BIOS). The POST tests a processor, a display card, a memory, a disk drive, an optical disk drive, a chipset, a keyboard and other peripheral devices of the computer and checks whether the peripheral devices operates normally or not. After the test completes, the computer initializes a hardware element and enters an operation system. However, the booting process of the computer may take a long time, which troubles the user.

Furthermore, the computer usually provides a booting menu for the user to do some setting. The booting menu should be triggered by a specific button during the booting process. Thus, the specific button should be initialized during the booting process, and then activates the booting menu. However, the booting time is lengthened, and it needs additional cost to dispose a button at the computer for activating the booting menu.

### BRIEF SUMMARY OF THE INVENTION

An electronic device booting method comprises following steps: booting the electronic device when a power button of the electronic device is triggered; determining whether a preset button of the electronic device is triggered; initializing at least one specific hardware element of the electronic device when the preset button is triggered, and executing an operation system before the specific hardware element is initiated when the preset button is not triggered.

An electronic device comprises a power button, a preset button, a specific hardware element, an embedded controller and a processing element. The embedded controller is electrically connected to the power button and the preset button. The processing element is electrically connected to the power button, the preset button, a specific hardware element and the embedded controller. The processing element includes a boot module, a determination module, an initialization module and an operation system execution module. The boot module boots the electronic device when the power button is triggered. The determination module drives the embedded controller to determine whether the preset button is triggered. When the preset button is triggered, the initialization module initializes a specific hardware element. When the preset button is not triggered, the operation system execution module executes an operation system before the specific hardware element of the electronic device is initialized.

After the electronic device boots, if the preset button is not triggered, the electronic device executes the operation system first and does not drive the specific hardware element, which can shorten the booting time of the electronic device greatly. Moreover, if preset steps relating to the specific hardware element need to be executed before the operation system is executed, the electronic device can detect whether a preset button is triggered after booting. When the power button and the preset button are one same button, the user only needs to trigger the power button twice to boot the electronic device and execute the preset steps relating to the specific hardware element, which is convenient in operation and save the cost of disposing a button at the electronic device.

These and other features, aspects and advantages of the present invention will become better understood with regard to the following description, appended claims, and accompanying drawings.

### BRIEF DESCRIPTION OF THE DRAWINGS

FIG. 1 is a flow chart showing steps of an electronic device booting method in an embodiment; and

FIG. 2 is a functional block diagram showing an electronic device in an embodiment.

### DETAILED DESCRIPTION OF THE EMBODIMENTS

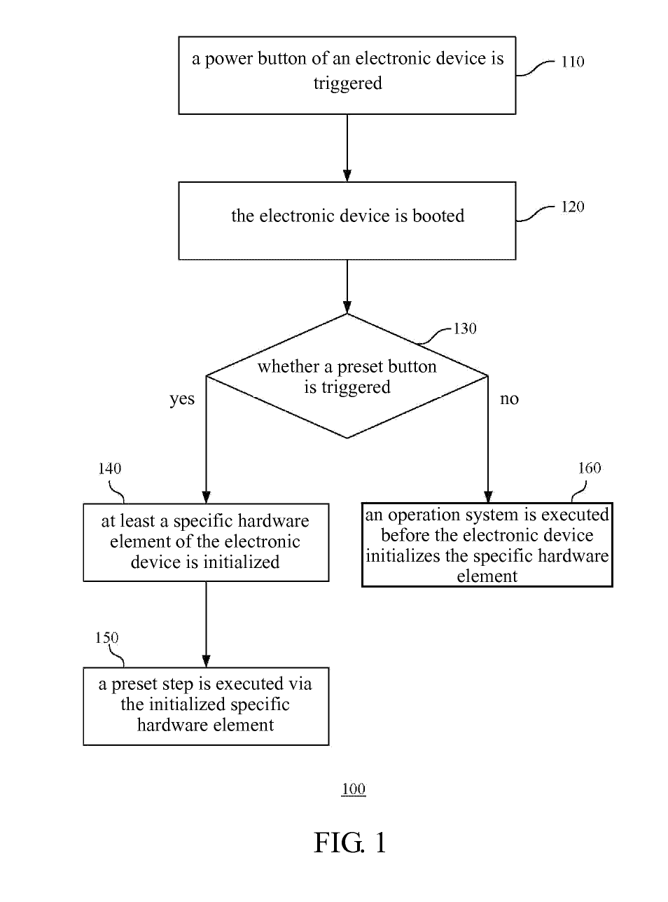

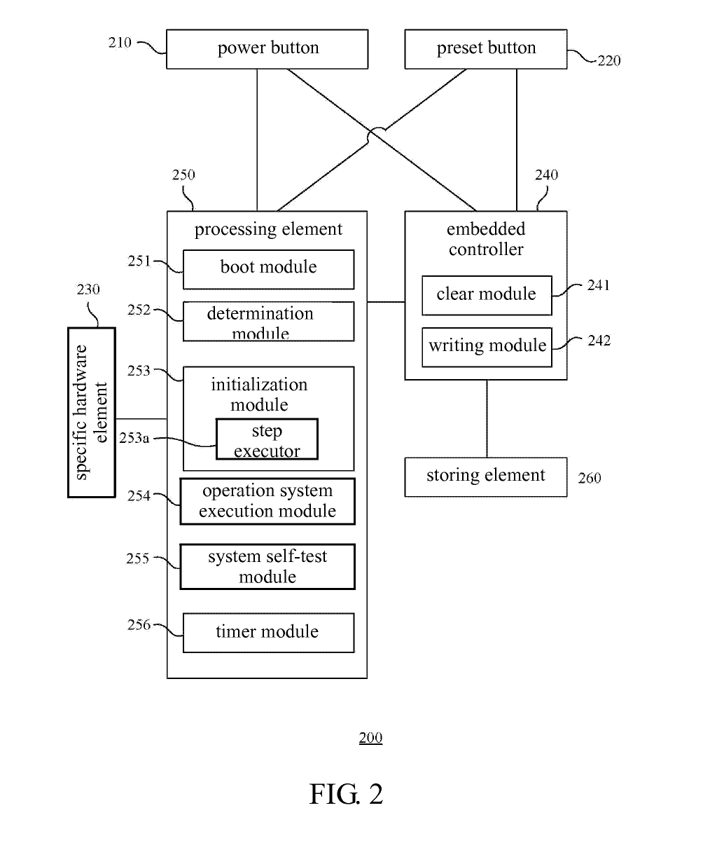

FIG. 1 is a flow chart showing steps of an electronic device booting method in an embodiment, and FIG. 2 is a functional block diagram showing an electronic device in an embodiment.

As shown in FIG. 2, an electronic device 200 includes a power button 210, a preset button 220, at least a specific hardware element 230, an embedded controller 240 and a processing element 250. The embedded controller 240 is electrically connected to the power button 210 and the preset button 220. The processing element 250 is electrically connected to the power button 210, the preset button 220, at least a specific hardware element 230 and the embedded controller 240. The embedded controller 240 may be a keyboard controller (KBC), which is not limited herein.

In the embodiment, the embedded controller 240 may be electrically connected to the processing element 250 via a south bridge chip of the electronic device 200, which is not limited herein. The specific hardware element 230 may include a display card, an input element, an information access element or a hardware element which is not needed before the electronic device 200 enters the operation system, which is not limited herein. The input element may be a keyboard, a mouse or a touch control element of a touch screen, which is not limited herein. The information access element may be an optical disk drive or a network card, which is not limited herein.

The processing element 250 includes a boot module 251, a determination module 252, an initialization module 253 and an operation system execution module 254. When the power button 210 is triggered, the boot module 251 boots the electronic device 200.

In the electronic device booting method shown in FIG. 1, the electronic device booting method may be achieved via a computer program stored in a readable recording medium of a computer, the computer reads the readable recording medium and executes the electronic device booting method. The readable recording medium of the computer may be a read-only memory (ROM), a flash memory, a soft disk, a hard disk, an optical disk, a flash drive, a tape or a database which can be accessed via a network.

Please refer to FIG. 1 and FIG. 2, the electronic device booting method 100 includes following steps: booting the electronic device (step 120) when the power button 210 of the electronic device 200 is triggered (step 110), and determining whether the preset button 220 of the electronic device is triggered (step 130).

In the embodiment, the preset button 220 is the power button 210. That is, in step 130, after the power button 210 is triggered and the electronic device 200 boots, it further determines whether the power button 210 is triggered again.

In another embodiment, the power button 210 and the preset button 220 may be different buttons. Moreover, the step 130 may be executed after the electronic device executes a system power-on self-test (POST). In another embodiment, it determines whether the preset button is triggered again (step 130) after the electronic device 200 boots (step 120) for preset time, which avoids an error in touching.

In step 140, when the preset button 220 is triggered in step 130, the specific hardware element 230 of the electronic device 200 is initialized.

Since the specific hardware element 230 of the electronic device 200 is initialized in step 140, a preset step is executed via the initialized specific hardware element 230 in step 150. In the embodiment, the specific hardware element 230 may be an input element, and the preset step executed in step 150 may be that operating a function menu (such as a booting menu) via the input element.

In another embodiment, the specific hardware element may also be a display card, and the preset step executed in step 150 may be displaying a function menu via the display card. Other preset steps may be executed via the initialized specific hardware element in step 150, which is not limited herein.

When it determines that the preset button 220 is not triggered in step 130, step 160 is executed. In step 160, an operation system is executed by the electronic device before the electronic device initializes the specific hardware element. Thus, if the preset button is not triggered after the electronic device boots, the operation system is executed and the specific hardware element is not drived, which shortens the electronic device booting time greatly.

The processing element may further include a system self-test module 255. The system self-test module 255 executes a system self-test for the electronic device 200. The determination module 252 starts to drive the embedded controller 240 to determine whether the preset button 220 is triggered after the system self-test is finished.

The processing element 250 may further include a timer module 256. After the electronic device 200 boots, the timer module 256 starts to count up. After the timer module 256 counts up to preset time, the determination module 252 drives the embedded controller 240 to determine whether the preset button 220 is triggered.

When the determination module 252 determines the preset button 220 is triggered, the initialization module 253 initializes the specific hardware element 230. In the embodiment, the initialization module 253 includes a step executor 253a. After the specific hardware element 230 is initialized, the step executor 253a executes a preset step via the specific hardware element 230. For example, when the specific hardware element 230 includes an input element, the preset step executed by the step executor 253a may be that operating a function menu (such as a booting menu) via the input element. For another example, when the specific hardware element 230 includes a display card, the preset step executed by the step executor 253a may be displaying a function menu via the display card. However, the step executor 253a can execute other preset steps via the initialized specific hardware element 230, which is not limited herein.

In the embodiment, the embedded controller 240 determines according to whether a storing element of the electronic device 200 stores triggering information of the preset button 220. Thus, the electronic device 200 further includes a storing element 260 electrically connected to the embedded controller 240. The storing element 260 includes a button triggering record block corresponding to the preset button 220. The embedded controller 240 includes a clear module 241 and a writing module 242.

When the power button 210 is triggered, the clear module 241 clears the button triggering record block of the storing element 260 corresponding to the preset button 220. When the preset button 220 is triggered, the writing module 242 writes a triggered information to the button triggering record block of the storing element 260. Thus, the determination module 252 drives the embedded controller 240 to determine whether the preset button 220 is triggered according to whether the button triggering record block of the storing element 260 stores the triggered information. When the button triggering record block of the storing element 260 stores the triggered information, the determination module 252 determines the preset button 220 is triggered. However, the embedded controller 240 may determine whether the preset button 220 of the electronic device 200 is triggered in other ways, which is not limited herein.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An electronic device booting method, comprising following steps:
booting the electronic device when a power button of the electronic device is triggered;
determining whether a preset button of the electronic device is triggered; and
initializing at least one specific hardware element of the electronic device when the preset button is triggered, and executing an operation system before the specific hardware element is initiated when the preset button is not triggered.

2. The electronic device booting method according to claim 1, wherein the preset button and the power button are one same button or different buttons.

3. The electronic device booting method according to claim 2, wherein after the electronic device is booted, it is determined whether the power button of the electronic device is triggered again.

4. The electronic device booting method according to claim 1, wherein after the electronic device is booted, the electronic device executes a power-on self-test (POST), and then determines whether the preset button of the electronic device is triggered.

5. The electronic device booting method according to claim 1, wherein it is determined whether the preset button of the electronic device is triggered or not after the electronic device is booted for preset time.

6. The electronic device booting method according to claim 1, wherein the electronic device further includes a storing element, the storing element includes a button triggering record block corresponding to the preset button, and the electronic device booting method further includes:
clearing the button triggering record block when the power button of the electronic device is triggered; and
writing a triggered information to the button triggering record block when the preset button of the electronic device is triggered.

7. The electronic device booting method according to claim 6, wherein whether the preset button of the electronic device is triggered is determined according to whether the button triggering record block stores the triggered information, and when the triggered information is stored in the button triggering record block, it determines that the preset button is triggered.

8. The electronic device booting method according to claim 1, wherein the specific hardware element is a display card, an input element or an information access element.

9. The electronic device booting method according to claim 1, wherein after the preset button is triggered and the specific hardware element of the electronic device is initialized, a preset step is executed via the specific hardware element.

10. The electronic device booting method according to claim 9, wherein the specific hardware element is an input element, and the preset step is that operating a function menu via the input element.

11. The electronic device booting method according to claim 9, wherein the specific hardware element is a display card, and the preset step is that displaying a function menu via the display card.

12. An electronic device, comprising:
a power button;
a preset button;
a specific hardware element;
an embedded controller electrically connected to the power button and the preset button; and
a processing element electrically connected to the power button, the preset button, the specific hardware element and the embedded controller, wherein the processing element includes:
a boot module booting the electronic device when the power button is triggered;
a determination module driving the embedded controller to determine whether the preset button is triggered;
an initialization module initializing the specific hardware element when the preset button is triggered; and
an operation system execution module executing an operation system before the specific hardware element of the electronic device is initialized when the preset button is not triggered.

13. The electronic device according to claim 12, wherein the preset button and the power button are one same button or different buttons.

14. The electronic device according to claim 12, wherein the processing element further includes:
a system self-test module executing a system self-test to the electronic device, wherein the determination module dives the embedded controller to determine whether the preset button is triggered after the system self-test is finished.

15. The electronic device according to claim 12, wherein the processing element further includes:
a timer module starting to count up after the electronic device boots, wherein the determination module drives the embedded controller to determine whether the preset button is triggered after the timer module counts up to a preset time.

16. The electronic device according to claim 12, wherein the electronic device further includes:
a storing element electrically connected to the embedded controller, wherein the storing element includes a button triggering record block corresponding to the preset button;
wherein the embedded controller includes:
a clear module clearing the button triggering record block when the power button is triggered;
a writing module writing triggered information to the button triggering record block when the preset button is triggered to make the determination module determine whether the preset button is triggered according to the triggered information.

17. The electronic device according to claim 12, wherein the specific hardware element is a display card, an input element or an information access element.

18. The electronic device according to claim 12, wherein the initialization module includes:
a step executor executing a preset step via the specific hardware element after the specific hardware element is initialized.

19. The electronic device according to claim 18, wherein the specific hardware element is an input element, and the preset step executed by the step executor is that operating a function menu via the input element.

20. The electronic device according to claim 17, wherein the specific hardware element is a display card, and the preset step executed by the step executor is that displaying a function menu via the display card.
